(19) United States
(12) Patent Application Publication
(10) Pub. No.: US 2020/0148888 A1
(43) Pub. Date: May 14, 2020

(54) COMPOSITION, FILM FORMING METHOD, AND METHOD OF MANUFACTURING OPTICAL SENSOR

(71) Applicant: FUJIFILM Corporation, Tokyo (JP)

(72) Inventors: Takahiro OKAWARA, Haibara-gun (JP); Yuki NARA, Haibara-gun (JP)

(73) Assignee: FUJIFILM Corporation, Tokyo (JP)

(21) Appl. No.: 16/744,694

(22) Filed: Jan. 16, 2020

Related U.S. Application Data
(63) Continuation of application No. PCT/JP2018/026412, filed on Jul. 13, 2018.

(30) Foreign Application Priority Data
Jul. 21, 2017 (JP) 2017-141704
May 21, 2018 (JP) 2018-096820

(51) Int. Cl. C09D 1/00; C08K 3/36; C09D 5/00; C08K 5/06; C09D 7/20

(52) U.S. Cl. CPC C09D 1/00; C08K 3/36; C09D 5/006; C08K 2201/006; C09D 7/20; C08K 2201/005; C08K 2201/003; C08K 5/06

(57) ABSTRACT

Provided is a composition with which a film having a lower refractive index and reduced defects can be formed. In addition, provided are a film forming method and a method of manufacturing an optical sensor. This composition includes colloidal silica particles and a solvent. In the colloidal silica particles, an average particle size D₁ that is measured using a dynamic light scattering method is 25 to 1000 nm and a ratio D₁/D₂ of the average particle size D₁ to an average particle size D₂ that is obtained from a specific surface area of the colloidal silica particles measured using a nitrogen adsorption method is 3 or higher. The solvent includes a solvent A1 having a boiling point of 245° C. or higher and a solubility parameter of lower than 11.3 (cal/cm³)^{0.5} and a solvent A2 having a boiling point of 120° C. or higher and lower than 245° C. and a solubility parameter of 11.3 (cal/cm³)^{0.5} or higher.

### CROSS-REFERENCE TO RELATED APPLICATIONS

This application is a Continuation of PCT International Application No. PCT/JP2018/026412 filed on Jul. 13, 2018, which claims priority under 35 U.S.C § 119(a) to Japanese Patent Application No. 2017-141704 filed on Jul. 21, 2017, and Japanese Patent Application No. 2018-096820 filed on May 21, 2018. Each of the above application(s) is hereby expressly incorporated by reference, in its entirety, into the present application.

### BACKGROUND OF THE INVENTION

### 1. Field of the Invention

The present invention relates to a composition including colloidal silica particles. In addition, the present invention relates to a film forming method and a method of manufacturing an optical sensor using the above-described composition.

### 2. Description of the Related Art

For example, an optical functional layer such as a low refractive index film is applied to a surface of a transparent substrate in order to prevent reflection of light to be incident. The application field of the optical functional layer is wide, and the optical functional layer is applied to products in various fields such as optical devices, construction materials, observation instruments, or window glass. As the material of the optical functional layer, various materials including not only organic materials but also inorganic materials are used and are targets to be developed. In particular, recently, the development of materials to be applied to the optical devices has progressed. Specifically, the search of materials having physical properties or workability suitable for a display panel, an optical lens, or an image sensor has progressed.

An optical functional layer that is applied to a precision optical device such as an image sensor is required to have fine and accurate processing formability. Therefore, in the related art, a gas phase method such as a vacuum deposition method or a sputtering method that is suitable for microfabrication has been adopted. As a material used in the gas phase method, for example, a single-layer film formed of MgF₂ or cryolite has been put into practice. In addition, the application of a metal oxide such as SiO₂, TiO₂, or ZrO₂ has also been attempted.

On the other hand, in the gas phase method such as a vacuum deposition method or a sputtering method, the device and the like are expensive, and thus the manufacturing costs may be high. Accordingly, recently, the manufacturing of the optical functional layer such as a low refractive index film using a composition including silica particles has been investigated (refer to WO2015/190374A and JP2016-135838A). In the techniques described in WO2015/190374A and JP2016-135838A, a film having a low refractive index can be manufactured.

### SUMMARY OF THE INVENTION

The present inventor conducted a further investigation on the composition including silica particles and found that, in a case where the composition is applied and dried, the silica particles are likely to aggregate such that defects such as unevenness are likely to occur on the obtained film surface. This way, there is room for further improvement for the use of the composition including silica particles.

Accordingly, an object of the present invention is to provide a composition with which a film having a low refractive index and reduced defects can be formed. In addition, another object of the present invention is to provide a film forming method and a method of manufacturing an optical sensor.

The above-described problems are solved by the following means.
<1>A composition comprising:
colloidal silica particles; and
a solvent,
in which in the colloidal silica particles, an average particle size D₁ that is measured using a dynamic light scattering method is 25 to 1000 nm and a ratio D₁/D₂ of the average particle size D₁ to an average particle size D₂ that is obtained by the following Expression (1) from a specific surface area S of the colloidal silica particles measured using a nitrogen adsorption method is 3 or higher, and
the solvent includes a solvent A1 having a boiling point of 245° C. or higher and a solubility parameter of lower than 11.3 (cal/cm³)^{0.5} and a solvent A2 having a boiling point of 120° C. or higher and lower than 245° C. and a solubility parameter of 11.3 (cal/cm³)^{0.5} or higher,

D₂=2720/S (1),
where D₂ represents an average particle size with a unit of nm and S represents a specific surface area of colloidal silica particles measured using a nitrogen adsorption method with a unit of m²/g.
<2> A composition comprising:
colloidal silica particles; and
a solvent,
in which in the colloidal silica particles, a plurality of spherical silica particles are linked in a planar shape, and
the solvent includes a solvent A1 having a boiling point of 245° C. or higher and a solubility parameter of lower than 11.3 (cal/cm³)^{0.5} and a solvent A2 having a boiling point of 120° C. or higher and lower than 245° C. and a solubility parameter of 11.3 (cal/cm³)^{0.5} or higher.
<3> A composition comprising:
colloidal silica particles; and
a solvent,
in which in the colloidal silica particles, a plurality of spherical silica particles are linked in a beaded shape, and
the solvent includes a solvent A1 having a boiling point of 245° C. or higher and a solubility parameter of lower than 11.3 (cal/cm³)^{0.5} and a solvent A2 having a boiling point of 120° C. or higher and lower than 245° C. and a solubility parameter of 11.3 (cal/cm³)^{0.5} or higher.
<4> The composition according to any one of <1>to <3>,
in which in the colloidal silica particles, a plurality of spherical silica particles having an average particle size of 1 to 80 nm are linked through a linking material.
<5> The composition according to <4>,
in which the linking material is a metal oxide-containing silica.
<6> The composition according to any one of <1>to <5>,
in which at least one selected from the solvent A1 or the solvent A2 is a protonic solvent.
<7> The composition according to any one of <1>to <5>,
in which the solvent A1 and the solvent A2 are protonic solvents.
<8> The composition according to any one of <1>to <7>,
wherein a content of the solvent A2 is 200 to 800 parts by mass with respect to 100 parts by mass of the solvent A1.
<9> The composition according to any one of <1>to <8>,
in which a total content of the solvent A1 and the solvent A2 is 30 to 70 mass % with respect to all the solvents.
<10> The composition according to any one of <1>to <9>, which is used for forming an optical functional layer.
<11> The composition according to any one of <1>to <9>, which is used for forming a partition wall.
<12> A film forming method comprising:
a step of applying the composition according to any one of <1>to <9>.
<13> A method of manufacturing an optical sensor comprising:
a step of applying the composition according to any one of <1>to <9>.

With the composition according to the present invention, a film having a low refractive index and reduced defects can be formed. In addition, according to the present invention, a film forming method and a method of manufacturing an optical sensor can be provided.

### BRIEF DESCRIPTION OF THE DRAWINGS

FIG. 1 is an enlarged view schematically illustrating a shape of colloidal silica particles.

### DESCRIPTION OF THE PREFERRED EMBODIMENTS

Hereinafter, the details of the present invention will be described.

In this specification, numerical ranges represented by “to” include numerical values before and after “to” as lower limit values and upper limit values.

In this specification, unless specified as a substituted group or as an unsubstituted group, a group (atomic group) denotes not only a group (atomic group) having no substituent but also a group (atomic group) having a substituent. For example, “alkyl group” denotes not only an alkyl group having no substituent (unsubstituted alkyl group) but also an alkyl group having a substituent (substituted alkyl group).

In this specification, unless specified otherwise, “exposure” denotes not only exposure using light but also drawing using a corpuscular beam such as an electron beam or an ion beam. Examples of the light used for exposure include an actinic ray or radiation, for example, a bright light spectrum of a mercury lamp, a far ultraviolet ray represented by excimer laser, an extreme ultraviolet ray (EUV ray), an X-ray, or an electron beam.

In this specification, “(meth)acrylate” denotes either or both of acrylate and methacrylate, “(meth)acryl” denotes either or both of acryl and methacryl, and “(meth)acryloyl” denotes either or both of acryloyl and methacryloyl.

In this specification, in a chemical formula, Me represents a methyl group, Et represents an ethyl group, Pr represents a propyl group, Bu represents a butyl group, and Ph represents a phenyl group.

In this specification, a weight-average molecular weight and a number-average molecular weight are defined as values in terms of standard polystyrene measured by gel permeation chromatography (GPC). As a measuring device and measurement conditions, the following condition 1 is basically used, and the following condition 2 is allowed depending on the solubility of a sample or the like. In this case, depending on the kind of a polymer, a more appropriate carrier (eluent) and a column suitable for the carrier may be selected and used. Other features can be found in JIS K 7252-1 to 4:2008.

(Condition 1)
Column: a column in which TOSOH TSK gel Super HZM-H, TOSOH TSK gel Super HZ4000, and TOSOH TSK gel Super HZ2000 are linked to each other
Carrier: tetrahydrofuran
Measurement temperature: 40° C.
Carrier flow rate: 1.0 ml/min
Sample concentration: 0.1 mass %
Detector: refractive index (RI) detector
Injection volume: 0.1 ml

(Condition 2)
Column: a column in which two TOSOH TSKgel Super AWM-H's are linked
Carrier: 10 mM LiBr/N-methylpyrrolidone
Measurement temperature: 40° C.
Carrier flow rate: 1.0 ml/min
Sample concentration: 0.1 mass %
Detector: refractive index (RI) detector
Injection volume: 0.1 ml

<Composition>

A composition according to an embodiment of the present invention comprises:
colloidal silica particles; and
a solvent,
in which the solvent includes a solvent A1 having a boiling point of 245° C. or higher and a solubility parameter of lower than 11.3 (cal/cm³)^{0.5} and a solvent A2 having a boiling point of 120° C. or higher and lower than 245° C. and a solubility parameter of 11.3 (cal/cm³)^{0.5} or higher.

In a first aspect of the composition according to the embodiment of the present invention, in the colloidal silica particles, an average particle size D₁ that is measured using a dynamic light scattering method is 25 to 1000 nm and a ratio D₁/D₂ of the average particle size D₁ to an average particle size D₂ that is obtained by the following Expression (1) from a specific surface area S of the colloidal silica particles measured using a nitrogen adsorption method is 3 or higher,

D₂=2720/S (1)

In the expression, D₂ represents an average particle size with a unit of nm and S represents a specific surface area of colloidal silica particles measured using a nitrogen adsorption method with a unit of m²/g.

In addition, in a second aspect of the composition according to the embodiment of the present invention, in the colloidal silica particles, a plurality of spherical silica particles are linked in a planar shape.

In addition, in a third aspect of the composition according to the embodiment of the present invention, in the colloidal silica particles, a plurality of spherical silica particles are linked in a beaded shape.

The composition according to the embodiment of the present invention includes the above-described colloidal silica particles such that the void volume of the obtained film increases and a film having a low refractive index can be formed. The composition according to the embodiment of the present invention includes not only the colloidal silica particles but also the solvent A1 and the solvent A2 such that, in a case where the composition is applied and dried, aggregation of the colloidal silica particles can be effectively suppressed, and the occurrence of defects such as unevenness on the obtained film surface can be effectively suppressed. The reason why this effect is obtained is presumed to be as follows. It is presumed that the solvent A2 has high affinity to the colloidal silica particles and the drying of the composition is promoted in a state where an appropriate amount of the solvent A2 is present in the vicinity of the colloidal silica particles. It is presumed that the composition according to the embodiment of the present invention further includes the above-described solvent A1 in addition to the above-described solvent A2 such that the drying rate of the composition is appropriately adjusted. This way, it is presumed that, since the composition includes the above-described solvent A1 and the above-described solvent A2, the aggregation of the colloidal silica particles during drying can be effectively suppressed, and thus a film having reduced defects can be formed. Hereinafter, each component of the composition according to the embodiment of the present invention will be described.

<<Colloidal Silica Particles>>

The composition according to the embodiment of the present invention includes colloidal silica particles. Examples of the colloidal silica particles used in the present invention include the following first to third aspects.
First aspect: an aspect in which an average particle size D₁ that is measured using a dynamic light scattering method is 25 to 1000 nm and a ratio D₁/D₂ of the average particle size D₁ to an average particle size D2 that is obtained by the following Expression (1) from a specific surface area S of the colloidal silica particles measured using a nitrogen adsorption method is 3 or higher
Second aspect: an aspect in which a plurality of spherical silica particles are linked in a planar shape
Third aspect: an aspect in which a plurality of spherical silica particles are linked in a beaded shape

The colloidal silica particles according to the first aspect may further satisfy the requirements of the colloidal silica particles according to the second aspect or the third aspect. In addition, the colloidal silica particles according to the second aspect may further satisfy the requirements of the colloidal silica particles according to the first aspect. In addition, the colloidal silica particles according to the third aspect may further satisfy the requirements of the colloidal silica particles according to the first aspect.

In this specification, “spherical” only has to be substantially spherical and may be deformed within a range where the effects of the present invention can be exhibited. For example, “spherical” refers to not only a shape having unevenness on a surface but also a flat shape having a major axis in a predetermined direction.

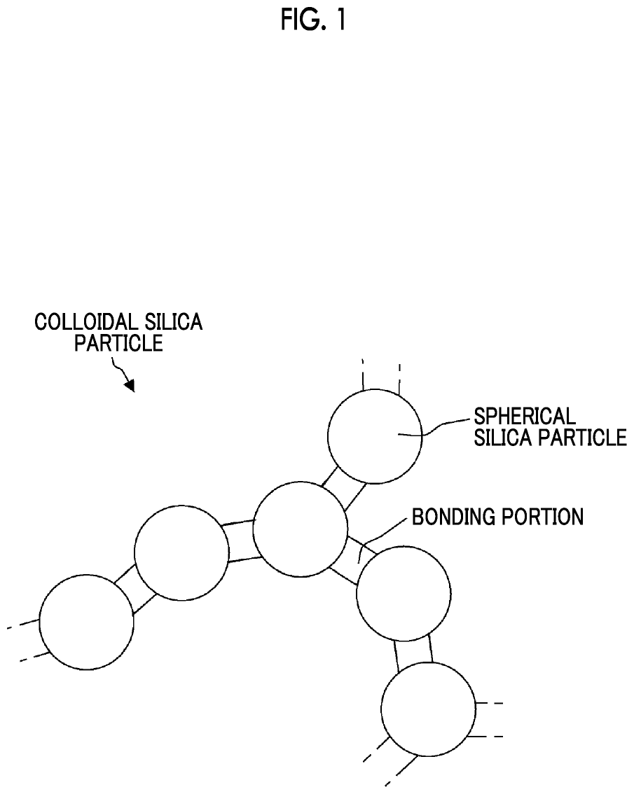

In addition, “a plurality of spherical silica particles are linked in a beaded shape” refers to a structure in which a plurality of spherical silica particles are linked in a linear and/or branched shape. For example, a structure in which a plurality of spherical silica particles are linked through bonding portions having a smaller outer diameter than the spherical silica particles as illustrated in FIG. 1 can be used. In addition, in the present invention, the structure in which “a plurality of spherical silica particles are linked in a beaded shape” refers to not only a structure in which a plurality of spherical silica particles are linked in a ring shape but also a plurality of spherical silica particles are linked in a chain-like shape having a terminal.

In addition, “a plurality of spherical silica particles are linked in a planar shape” refers to a structure in which a plurality of spherical silica particles are linked on substantially the same plane. “Substantially the same plane” refers to not only the same plane but also a case where the silica particles are vertically shifted from the same plane. For example, the silica particles may be vertically shifted in a range where the particle size of the silica particles is 50% or lower.

In the colloidal silica particles used in the present invention, it is preferable that the ratio D₁/D₂ of the average particle size D₁ that is measured using a dynamic light scattering method to the average particle size D₂ that is obtained by Expression (1) is 3 or higher. The upper limit of the D₁/D2 is not particularly limited and is preferably 1000 or lower, more preferably 800 or lower, and still more preferably 500 or lower. By adjusting D₁/D₂ to be in the above-described range, excellent optical characteristics can be exhibited, and further aggregation during drying can be effectively suppressed. The value of D₁/D₂ in the colloidal silica particles is also an index indicating the degree to which the spherical silica particles are linked.

The average particle size D₂ of the colloidal silica particles can be considered as an average particle size similar to that of primary particles of the spherical silica. The average particle size D₂ is preferably 1 nm or more, more preferably 3 nm or more, still more preferably 5 nm or more, and still more preferably 7 nm or more. The upper limit is preferably 100 nm or less, more preferably 80 nm or less, still more preferably 70 nm or less, still more preferably 60 mu or less, and still more preferably 50 nm or less.

The average particle size D₂ can be replaced with a circle equivalent diameter (D0) of a projection image of a spherical portion measured using a transmission electron microscope (TEM). The average particle size as the circle equivalent diameter is evaluated as a number average value of 50 or more particles unless specified otherwise.

The average particle size D₁ of the colloidal silica particles can be considered as number average particle size of secondary particles obtained by aggregation of the plurality of spherical silica particles. Accordingly, typically, a relationship of D₁>D₂ is satisfied. The average particle size D₁ is preferably 25 nm or more, more preferably 30 nm or more, and still more preferably 35 nm or more. The upper limit is preferably 1000 nm or less, more preferably 700 nm or less, still more preferably 500 nm or less, and still more preferably 300 nm or less.

Unless specified otherwise, the average particle size D1 of the colloidal silica particles is measured using a dynamic light scattering particle size distribution analyzer (manufactured by Nikkiso Co., Ltd., Nanotrac Wave-EX150 (trade name)). The procedure is as follows. 20 ml of a sample dispersion of colloidal silica particles is collected in a sample bottle and is diluted with toluene such that the concentration of solid contents is 0.2 mass %. The diluted sample solution is used for the test immediately after being irradiated with ultrasonic waves of 40 kHz for 1 minute. Data is obtained 10 times using a 2 ml quartz cell for measurement at a temperature of 25° C., and the obtained “number average” is obtained as the average particle size. Other detailed conditions and the like can be found in JIS Z8828: 2013 “Particle Size Analysis-Dynamic Light Scattering” as necessary. For each level, five samples are prepared and the average value thereof is adopted.

In the present invention, it is preferable that in the colloidal silica particles, a plurality of spherical silica particles having an average particle size of 1 to 80 nm are linked through a linking material. The upper limit of the average particle size of the spherical silica particles is preferably 70 nm or less, more preferably 60 nm or less, and still more preferably 50 nm or less. In addition, the lower limit of the average particle size of the spherical silica particles is preferably 3 nm or more, more preferably 5 nm or more, and still more preferably 7 nm or more. As the value of the spherical silica particles in the present invention, an average particle size that is obtained from a circle equivalent diameter of a projection image of a spherical portion measured using a transmission electron microscope (TEM) is used.

Examples of the linking material through which the spherical silica particles are linked include a metal oxide-containing silica. Examples of the metal oxide include an oxide of a metal selected from Ca, Mg, Sr, Ba, Zn, Sn, Pb, Ni, Co, Fe, Al, In, Y, or Ti. Examples of the metal oxide-containing silica include a reactant and a mixture of the metal oxide and silica (SiO₂). The details of the linking material can be found in WO2000/015552A, the content of which is incorporated herein by reference.

The number of spherical silica particles linked is preferably 3 or more and more preferably 5 or more. The upper limit is preferably 1000 or less, more preferably 800 or less, and still more preferably 500 or less. The number of spherical silica particles linked can be measured using a TEM.

In the composition according to the embodiment of the present invention, the colloidal silica particle may be used in the form of a particle solution (sol). For example, a silica sol described in JP4328935B can be used. Examples of a medium in which the colloidal silica particles are dispersed include an alcohol (for example, methanol, ethanol, or isopropanol (IPA)), ethylene glycol, a glycol ether (for example, propylene glycol monomethyl ether), and a glycol ether acetate (for example, propylene glycol monomethyl ether acetate). In addition, the solvent A1, the solvent A2, and the like described below can also be used. The SiO₂ concentration in the particle solution (sol) is preferably 5 to 40 mass %.

As the particle solution (sol), a commercially available product can also be used. Examples of the commercially available product include: “SNOWTEX OUP”, “SNOWTEX UP”, “IPA-ST-UP”, “SNOWTEX PS-M”, “SNOWTEX PS-MO”, “SNOWTEX PS-S”, and “SNOWTEX PS-SO” manufactured by Nissan Chemical Industries Ltd.; “FINE CATALOID F-120” manufactured by JGC C&C; and “QUARTRON PL” manufactured by Fuso Chemical Co., Ltd.

In the composition according to the embodiment of the present invention, the content of the colloidal silica particles is preferably 3 to 15 mass % with respect to the total amount of the composition. The lower limit is preferably 4 mass % or higher and more preferably 5 mass % or higher. The upper limit is preferably 12 mass % or lower and more preferably 10 mass % or lower.

In the composition according to the embodiment of the present invention, the content of the colloidal silica particles is preferably 0.1 mass % or higher, more preferably 1 mass % or higher, and still more preferably 2 mass % or higher with respect to the total solid content of the composition. The upper limit is preferably 99.99 mass % or lower, more preferably 99.95 mass % or lower, and still more preferably 99.9 mass % or lower. By adjusting the content of the colloidal silica particles to be the lower limit value or higher, an antireflection effect is high at a low refractive index, and the wettability of the film surface can be improved, which is preferable. By adjusting the content of the colloidal silica particles to be the upper limit value or lower, application properties and curing properties can be improved, which is preferable.

<<Alkoxysilane Hydrolysate>>

It is preferable that the composition according to the embodiment of the present invention includes at least one component (referred to as “alkoxysilane hydrolysate”) selected from alkoxysilane or a hydrolysate of alkoxysilane. The composition according to the embodiment of the present invention includes the alkoxysilane hydrolysate such that the colloidal silica particles can be strongly bonded to each other during film formation and an effect of increasing the void volume in the film during film formation can be exhibited. In addition, by using the alkoxysilane hydrolysate, the wettability of the film surface can be improved.

It is preferable that the alkoxysilane hydrolysate is produced by condensation due to hydrolysis of the alkoxysilane compound (A), and it is more preferable that the alkoxysilane hydrolysate is produced by condensation due to hydrolysis of the alkoxysilane compound and a fluoroalkyl group-containing alkoxysilane compound (B).

As the alkoxysilane compound (A), a compound represented by the following Formula (S1) is preferable.

Si(OR^{S1})ₚ(R^{S2})_{q} (S1)

In the formula, R^{S1} represents an alkyl group having 1 to 5 carbon atoms, an alkenyl group having 2 to 5 carbon atoms, or an aryl group having 6 to 10 carbon atoms. Among these, an alkyl group having 1 to 5 carbon atoms is preferable. R^{S2} represents an alkyl group having 1 to 5 carbon atoms, an alkenyl group having 2 to 5 carbon atoms, or an aryl group having 6 to 10 carbon atoms. Among these, an alkyl group having 1 to 5 carbon atoms is preferable. p represents an integer of 1 to 4. q represents an integer of 0 to 3. p+q represents 4.

Specific examples of the alkoxysilane compound (A) include tetramethoxysilane, tetraethoxysilane, methyl trimethoxysilane, ethyl trimethoxysilane, methyltriethoxysilane, ethyltriethoxysilane, vinyl trimethoxysilane, vinyltriethoxysilane, phenyl trimethoxysilane, and phenyltriethoxysilane. In particular, tetramethoxysilane is preferable because a film having a high hardness can be obtained.

It is preferable that the fluoroalkyl group-containing alkoxysilane compound (B) is a compound represented by the following Formula (S2-1) or (S2-2).

CF₃(CR^{F}₂)ₖSi(OR^{S3})₃ (S2-1)

CF₃(CF₂)ₙCH₂CH₂Si(OR^{S3})₃ (S2-2)

In the formula, R^{F} represents a hydrogen atom, a halogen atom (for example, a fluorine atom), or a substituent represented by R^{S3} and preferably a hydrogen atom or a halogen atom (for example, a fluorine atom). k represents an integer of 0 to 10.

R^{S3} represents an alkyl group having 1 to 5 carbon atoms, an alkenyl group having 2 to 5 carbon atoms, or an aryl group having 6 to 10 carbon atoms. Among these, an alkyl group having 1 to 5 carbon atoms is preferable. n represents an integer of 0 to 8.

R^{S1} to R^{S3} may have any substituent such as a halogen atom (for example, a fluorine atom).

Specific examples of the fluoroalkyl group-containing alkoxysilane compound include trifluoropropyltrimethoxysilane, trifluoropropyltriethoxysilane, tridecafluorooctyltrimethoxysilane, tridecafluorooctyltriethoxysilane, heptadecafluorodecyltrimethoxysilane, and heptadecafluorodecyltriethoxysilane.

The hydrolysate of the alkoxysilane compound (A) and the fluoroalkyl group-containing alkoxysilane compound (B) can be produced by hydrolysis (condensation) thereof in an organic solvent. Specifically, it is preferable that the alkoxysilane compound (A) and the fluoroalkyl group-containing alkoxysilane compound (B) are mixed at a mass ratio of 1:0.3 to 1.6 (A:B). The ratio between the alkoxysilane compound (A) and the fluoroalkyl group-containing alkoxysilane compound (B) is preferably 1:0.5 to 1.3 (A:B) by mass ratio. It is preferable that 0.5 to 5 parts by mass of water, 0.005 to 0.5 parts by mass of an organic acid (for example, formic acid), and 0.5 to 5 parts by mass of an organic solvent (preferably alcohol, glycol ether, or glycol ether acetate) with respect to 1 part by mass of the mixture are mixed with each other such that the hydrolysis reaction of the alkoxysilane compound (A) and the fluoroalkyl group-containing alkoxysilane compound (B) progresses. In particular, the proportion of water is preferably 0.8 to 3 parts by mass. As the water, for example, ion exchange water or pure water is preferably used to prevent infiltration of impurities. The proportion of the organic acid is preferably 0.008 to 0.2 parts by mass. Specific examples of alcohol, glycol ether, and glycol ether acetate used in the organic solvent can be found in paragraph “0027” of WO2015/190374A, the content of which is incorporated herein by reference. The proportion of the organic solvent is preferably 0.5 to 3.5 parts by mass.

In a case where the composition according to the embodiment of the present invention includes the alkoxysilane hydrolysate, it is preferable that the colloidal silica particles are prepared by mixing the components such that the SiO₂ content in the colloidal silica particles is 5 to 500 parts by mass with respect to 10 parts by mass of the SiO₂ content in the alkoxysilane hydrolysate, and it is more preferable that the colloidal silica particles are prepared by mixing the components such that the SiO₂ content in the colloidal silica particles is 100 to 300 parts by mass with respect to 10 parts by mass of the SiO₂ content in the alkoxysilane hydrolysate. The composition according to the embodiment of the present invention includes the alkoxysilane hydrolysate and the colloidal silica particles at the above-described ratio, a film having a low refractive index and a high hardness can be formed.

In a case where the composition according to the embodiment of the present invention includes the alkoxysilane hydrolysate, the total content of the colloidal silica particles and the alkoxysilane hydrolysate is preferably 0.1 mass % or higher, more preferably 1 mass % or higher, and still more preferably 2 mass % or higher with respect to the total solid content in the composition. The upper limit is preferably 99.99 mass % or lower, more preferably 99.95 mass % or lower, and still more preferably 99.9 mass % or lower.

<<Other Silica Particles>>

The composition according to the embodiment of the present invention may further include silica particles (hereinafter, other silica particles) other than the colloidal silica particles according to any one of the first to third aspects. Examples of the other silica particles include hollow silica particles, solid silica particles, porous silica particles, and a cage type siloxane polymer. Examples of a commercially available product of the hollow silica particles include THRULYA 4110 (manufactured by JGC C&C). Examples of a commercially available product of the solid silica particles include PL-2L-IPA (manufactured by Fuso Chemical. Co., Ltd.).

In a case where the composition according to the embodiment of the present invention includes the other silica particles, the content of the other silica particles is preferably 0.1 to 30 mass % with respect to the total solid content of the composition. The upper limit is preferably 20 mass % or lower, more preferably 10 mass % or lower, and still more preferably 5 mass % or lower. The lower limit is preferably 0.3 mass % or higher, more preferably 0.5 mass % or higher, and still more preferably 1 mass % or higher.

In addition, it is also preferable that the composition according to the embodiment of the present invention does not substantially include the other silica particles. According to this aspect, the occurrence of defects can be more effectively suppressed. A case where the composition according to the embodiment of the present invention does not substantially include the other silica particles represents that the content of the other silica particles is 0.05 mass % or lower, preferably 0.01 mass % or lower, and more preferably 0 mass % with respect to the total solid content of the composition.

<<Solvent>>

The composition according to the embodiment of the present invention includes a solvent. Examples of the solvent include an organic solvent (an aliphatic compound, a halogenated hydrocarbon compound, an alcohol compound, an ether compound, an ester compound, a ketone compound, a nitrile compound, an amide compound, a sulfoxide compound, or an aromatic compound) and water. The respective examples will be shown below.

Aliphatic Compound

For example, hexane, heptane, cyclohexane, methylcyclohexane, octane, pentane, or cyclopentane.

Halogenated Hydrocarbon Compound

For example, methylene chloride, chloroform, dichloromethane, ethane dichloride, carbon tetrachloride, trichloroethylene, tetrachloroethylene, epichlorohydrin, monochlorobenzene, orthodichlorobenzene, allylchloride, HCFC, methyl monochloroacetate, ethyl monochloroacetate, monochloroacetate, trichloroacetate, methyl bromide, or tri(tetra)chloroethylene.

Alcohol Compound

For example, methanol, ethanol, 1-propanol, 2-propanol, 2-butanol, ethylene glycol, propylene glycol, glycerin, 1,6-hexanediol, cyclohexanediol, sorbitol, xylitol, 2-methyl-2,4-pentanediol, 1,3-butanediol, or 1,4-butanediol.

Ether Compound (including a hydroxyl group-containing ether compound)

For example, dimethyl ether, diethyl ether, diisopropyl ether, dibutyl ether, t-butyl methyl ether, cyclohexyl methyl ether, anisole, tetrahydrofuran, ethylene glycol monomethyl ether, ethylene glycol monobutyl ether, diethylene glycol, dipropylene glycol, propylene glycol monomethyl ether, diethylene glycol monomethyl ether, diethylene glycol dibutyl ether, triethylene glycol, polyethylene glycol, propylene glycol monomethyl ether, dipropylene glycol monomethyl ether, tripropylene glycol monomethyl ether, diethylene glycol monobutyl ether, diethylene glycol monobutyl ether, triethylene glycol monomethyl ether, triethylene glycol monobutyl ether, tetraethylene glycol dimethyl ether, ethylene glycol monophenyl ether, diethylene glycol monohexyl ether, diethylene glycol monobenzyl ether, tripropylene glycol monomethyl ether, polyethylene glycol monomethyl ether, or polyethylene glycol dimethyl ether.

Ester Compound,

For example, ethyl acetate, ethyl lactate, 2-(1-methoxy)propyl acetate, propylene glycol monomethyl ether acetate, ethyl 3-ethoxypropionate, or propylene carbonate.

Ketone Compound

For example, acetone, methyl ethyl ketone, methyl isobutyl ketone, cyclohexanone, or 2-heptanone.

Nitrile Compound

For example, acetonitrile.

Amide Compound

For example, N,N-dimethylformamide, 1-methyl-2-pyrrolidone, 2-pyrrolidinone, 1,3-dimethyl-2-imidazolidinone, 2-pyrrolidinone, ε-caprolactam, formamide, N-methyl formamide, acetamide, N-methylacetamide, N,N-dimethylacetamide, N-methylpropaneamide, hexamethylphosphoric amide, 3-methoxy-N,N-dimethylpropanamide, or 3-butoxy-N,N-dimethylpropanamide.

Sulfoxide Compound

For example, dimethyl sulfoxide.

Aromatic Compound

For example, benzene or toluene.

In the present invention, the solvent includes a solvent A1 having a boiling point of 245° C. or higher and a solubility parameter of lower than 11.3 (cal/cm³)^{0.5} and a solvent A2 having a boiling point of 120° C. or higher and lower than 245° C. and a solubility parameter of 11.3 (cal/cm³)^{0.5} or higher. 1 (cal/cm³)^{0.5} is 2.0455 MPa^{0.5}.

The solubility parameter of the solvent is a value calculated using the Okitsu method. The boiling point of the solvent is a value at 1 atm. In addition, in the present invention, it is assumed that the boiling point of a solvent that is not observed to have a boiling point of lower than 245° C. is 245° C. or higher.

In the present invention, it is preferable that at least one selected from the solvent A1 or the solvent A2 is a protonic solvent, and it is more preferable that both the solvent A1 and the solvent A2 are protonic solvents. By using the protonic solvent as the solvent A1 and the solvent A2, the affinity to the colloidal silica particle increases, and the aggregation of the colloidal silica particles in the drying step can be more effectively suppressed. In particular, in a case where both the solvent A1 and the solvent A2 are the protonic solvents, the above-described effect becomes more significant.

The boiling point of the solvent A1 is 245° C. or higher, preferably 260° C. or higher, and more preferably 280° C. or higher. In a case where the boiling point of the solvent A1 is 245° C. or higher, by using the solvent A1 in combination of the solvent A2, the drying rate of the composition can be appropriately adjusted, and the occurrence of defects can be effectively suppressed. The upper limit of the boiling point of the solvent A1 is preferably 400° C. or lower.

The solubility parameter of the solvent A1 is lower than 11.3 (cal/cm³)^{0.5}, preferably 11.1 (cal/cm³)^{0.5} or lower, more preferably 10.9 (cal/cm³)^{0.5} or lower, and still more preferably 10.7 (cal/cm³)^{0.5} or lower. The lower limit is preferably 7.5 (cal/cm³)^{0.5} or higher, more preferably 8.0 (cal/cm³)^{0.5} or higher, and still more preferably 8.5 (cal/cm³)^{0.5} or higher. In a case where the solubility parameter of the solvent A1 is in the above-described range, the affinity to moisture can be reduced, and thus thickening over time caused by infiltration of moisture during the storage of the composition can be suppressed.

The molecular weight of the solvent A1 (in the case of a polymer, the weight-average molecular weight) is preferably 300 or higher, more preferably 400 or higher, and still more preferably 500 or higher. The upper limit is, for example, preferably 10,000 or lower, more preferably 5,000 or lower, still more preferably 3,000 or lower, still more preferably 1,000 or lower, and still more preferably 900 or lower.

Specific examples of the solvent A1 include polyethylene glycol monomethyl ether (solubility parameter=lower than 11.3 (cal/cm³)^{0.5}, boiling point=245° C. or higher), triethylene glycol monomethyl ether (solubility parameter=10.5 (cal/cm³)^{0.5}, boiling point=248° C.), triethylene glycol monobutyl ether (solubility parameter=9.6 (cal/cm³)^{0.5}, boiling point=278° C.), 3-butoxy-N,N-dimethylpropanamide (solubility parameter=10.3 (cal/cm³)^{0.5}, boiling point=252° C.), and tripropylene glycol monomethyl ether (solubility parameter=9.1 (cal/cm³)^{0.5}, boiling point=248° C.). In addition, a mixture of a plurality of polyethylene glycol monomethyl ethers having different molecular weight distributions may be used.

The boiling point of the solvent A2 is 120° C. or higher and lower than 245° C. The upper limit of the boiling point is preferably 220° C. or lower and more preferably 200° C. or lower. The lower limit of the boiling point is preferably 130° C. or higher and more preferably 140° C. or higher. In a case where the boiling point of the solvent A2 is in the above-described range, by using the solvent A2 in combination of the solvent A1, the drying rate of the composition can be appropriately adjusted, and the occurrence of defects can be effectively suppressed. In addition, a difference between the boiling point of the solvent A1 and the boiling point of the solvent A2 is preferably 80° C. or higher, more preferably 100° C. or higher, and still more preferably 120° C. or higher. The upper limit is preferably 200° C. or lower, more preferably 180° C. or lower, and still more preferably 160° C. or lower. In a case where the difference between the boiling points is in the above-described range, the drying properties of the composition can be appropriately adjusted, and the aggregation of the colloidal silica particles in the drying step can be more effectively suppressed.

The solubility parameter of the solvent A2 is 11.3 (cal/cm³)^{0.5} or higher, preferably 11.5 (cal/cm³)^{0.5} or higher, more preferably 11.7 (cal/cm³)^{0.5} or higher, and still more preferably 11.9 (cal/cm³)^{0.5} or higher. The upper limit is preferably 20 (cal/cm³)^{0.5} or lower, more preferably 18 (cal/cm³)^{0.5} or lower, and still more preferably 16 (cal/cm³)^{0.5} or lower. In a case where the solubility parameter of the solvent A2 is 11.3 (cal/cm³)^{0.5} or higher, the affinity to the colloidal silica particles is excellent.

In addition, a difference between the solubility parameter of the solvent A1 and the solubility parameter of the solvent A2 is preferably 0.5 (cal/cm³)^{0.5} or higher, more preferably 0.8 (cal/cm³)^{0.5} or higher, and still more preferably 1.0 (cal/cm³)^{0.5} or higher. The upper limit is preferably 6 (cal/cm³)^{0.5} or lower, more preferably 4 (cal/cm³)^{0.5} or lower, and still more preferably 2 (cal/cm³)^{0.5} or lower. In a case where the difference between the solubility parameters is 0.5 (cal/cm³)^{0.5} or higher, the solvent A2 more preferentially surrounds the colloidal silica particles, and the aggregation of the colloidal silica particles can be effectively suppressed. In addition, in a case where the difference between the solubility parameters is 6 (cal/cm³)^{0.5} or lower, regarding the solvent A1 having lower affinity to the colloidal silica particles than the solvent A2, the affinity to the colloidal silica particles can be appropriately secured, and the aggregation of the colloidal silica particles in the drying step can be effectively suppressed.

The molecular weight of the solvent A2 is preferably 30 to 300. The lower limit is more preferably 50 or higher and still more preferably 80 or higher. The upper limit is preferably 250 or lower and more preferably 200 or lower.

Specific examples of the solvent A2 include ethyl lactate (solubility parameter=111 (cal/cm³)^{0.5}, boiling point=154° C.), propylene carbonate (solubility parameter=13.3 (cal/cm³)^{0.5}, boiling point=240° C.), and ethylene glycol (solubility parameter=14.2 (cal/cm³)^{0.5}, boiling point=197° C.).

The composition according to the embodiment of the present invention may include solvents (hereinafter, also referred to as “the other solvents”) other than the solvent A1 and the solvent A2. Examples of the other solvents include a solvent A3 having a boiling point of 245° C. or higher and a solubility parameter of 11.3 (cal/cm³)^{0.5} or higher and a solvent A4 having a boiling point of 120° C. or higher and lower than 245° C. and a solubility parameter of lower than 11.3 (cal/cm³)^{0.5}, and a solvent A5 having a boiling point of lower than 120° C. As the other solvents, the solvent A4 and the solvent A5 are preferable.

The lower limit of the solubility parameter of the solvent A4 is preferably 11.5 (cal/cm³)^{0.5} or higher, more preferably 11.7 (cal/cm³)^{0.5} or higher, and still more preferably 11.9 (cal/cm³)^{0.5} or higher. In addition, the boiling point of the solvent A4 is preferably 130° C. to 230° C., more preferably 140° C. to 220° C., and still more preferably 150° C. to 210° C.

The boiling point of the solvent A5 is preferably 60° C. to 110° C., more preferably 65° C. to 95° C., and still more preferably 70° C. to 90° C. In addition, the solubility parameter of the solvent A5 is preferably 8 to 20 (cal/cm³)^{0.5}, more preferably 9 to 18 (cal/cm³)^{0.5}, and still more preferably 10 to 16 (cal/cm³)^{0.5}.

Specific preferable examples of the other solvents include propylene glycol monomethyl ether, ethanol, methanol, water, 1-propanol, 2-propanol, 1-butanol, 2-butanol, glycerin, 1,3-butylene glycol diacetate.

In the composition according to the embodiment of the present invention, the content of the solvent is preferably 70 to 99 mass % with respect to the total amount of the composition. The upper limit is preferably 97 mass % or lower, more preferably 95 mass % or lower, and still more preferably 93 mass % or lower. The lower limit is preferably 75 mass % or higher, more preferably 80 mass % or higher, and still more preferably 85 mass % or higher.

In addition, in the composition according to the embodiment of the present invention, the content of the solvent A2 is preferably 200 to 800 parts by mass with respect to 100 parts by mass of the solvent A1. The upper limit is preferably 700 parts by mass or less and more preferably 600 parts by mass or less. The lower limit is preferably 300 parts by mass or more and more preferably 400 parts by mass or more. In a case where the ratio between the solvent A1 and the solvent A2 is in the above-described range, the occurrence of defects can be more effectively suppressed. Further, the application properties of the composition are excellent, a film having an excellent surface shape in which the occurrence of striation or the like is suppressed can be formed.

In addition, in the solvent included in the composition according to the embodiment of the present invention, the content of the solvent A4 is preferably 1 to 50 parts by mass with respect to 100 parts by mass of the total amount of the solvent A1 and the solvent A2. The upper limit is preferably 40 parts by mass or less and more preferably 30 parts by mass or less. The lower limit is preferably 3 parts by mass or more and more preferably 5 parts by mass or more. In a case where the content of the solvent A4 is in the above-described range, the occurrence of defects can be more effectively suppressed.

In addition, in the solvent included in the composition according to the embodiment of the present invention, the content of the solvent A5 is preferably 1 to 50 parts by mass with respect to 100 parts by mass of the total amount of the solvent A1 and the solvent A2. The upper limit is preferably 40 parts by mass or less and more preferably 30 parts by mass or less. The lower limit is preferably 3 parts by mass or more and more preferably 5 parts by mass or more. In a case where the content of the solvent A5 is in the above-described range, the occurrence of defects can be more effectively suppressed.

In addition, in the solvent included in the composition according to the embodiment of the present invention, the total content of the solvent A4 and the solvent A5 is preferably 3 to 100 parts by mass with respect to 100 parts by mass of the total amount of the solvent A1 and the solvent A2. The upper limit is preferably 80 parts by mass or less and more preferably 60 parts by mass or less. The lower limit is preferably 10 parts by mass or more and more preferably 20 parts by mass or more. In a case where the total content of the solvent A4 and the solvent A5 is in the above-described range, the occurrence of defects can be more effectively suppressed.

In addition, in the solvent included in the composition according to the embodiment of the present invention, the total content of the solvent A1 and the solvent A2 is preferably 30 to 70 mass %. The upper limit is preferably 65 mass % or lower, more preferably 60 mass % or lower, and still more preferably 55 mass % or lower. The lower limit is preferably 35 mass % or higher, more preferably 40 mass % or higher, and still more preferably 45 mass % or higher.

In addition, in the solvent included in the composition according to the embodiment of the present invention, the content of water is preferably 0.01 to 1 mass %. The upper limit is preferably 0.8 mass % or lower, more preferably 0.6 mass % or lower, and still more preferably 0.4 mass % or lower. The lower limit is preferably 0.05 mass % or higher, more preferably 0.08 mass % or higher, and still more preferably 0.1 mass % or higher. By adjusting the content of water to be in the above-described range, the aggregation of the colloidal silica particles in the drying step can be effectively suppressed.

In addition, in the solvent included in the composition according to the embodiment of the present invention, the total content of ethanol and methanol is preferably 1 to 10 mass %. The upper limit is preferably 8 mass % or lower, more preferably 6 mass % or lower, and still more preferably 4 mass % or lower. The lower limit is preferably 2.5 mass % or higher, more preferably 3 mass % or higher, and still more preferably 3.5 mass % or higher. By adjusting the total content of ethanol and methanol to be in the above-described range, the aggregation of the colloidal silica particles in the drying step can be effectively suppressed. In this case, the solvent may include either or both of ethanol and methanol. In addition, in a case where the solvent includes both ethanol and methanol, a mixing ratio between methanol and ethanol is not particularly limited. For example, methanol:ethanol is preferably 8:1 to 1:8 (mass ratio).

The composition according to the embodiment of the present invention may include one solvent A1 or two or more solvents A1. In a case where the composition includes two or more solvents A1, it is preferable that the total content of the two or more resins is in the above-described range. Regarding the solvent A2 and the other solvents, the same shall be applied to the other solvents.

<<Surfactant>>

The composition according to the embodiment of the present invention may include a surfactant. As the surfactant, any one of a nonionic surfactant, a cationic surfactant, or an anionic surfactant may be used. As the nonionic surfactant, a fluorine surfactant is preferable. In particular, a fluorine surfactant, an anionic surfactant, a cationic surfactant is preferable, and a fluorine surfactant is more preferable.

In the present invention, it is preferable that the composition includes a surfactant having a polyoxyalkylene structure. The polyoxyalkylene structure refers to a structure in which an alkylene group and a divalent oxygen atom are present adjacent to each other, and specific examples thereof include an ethylene oxide (EO) structure and a propylene oxide (PO) structure. The polyoxyalkylene structure may constitute a graft chain of an acrylic polymer.

In a case where the surfactant is a polymer compound, the weight-average molecular weight is preferably 1500 or higher, more preferably 2500 or higher, still more preferably 5000 or higher, and still more preferably 10000 or higher. The upper limit is preferably 50000 or lower, more preferably 25000 or lower, and still more preferably 17500 or lower.

The fluorine surfactant is preferably a polymer surfactant having a polyethylene main chain. In particular, a polymer surfactant having a poly(meth)crylate structure is preferable. In particular, in the present invention, a copolymer of a (meth)acrylate constitutional unit having the polyoxyalkylene structure and a fluorinated alkylaciylate constitutional unit is preferable.

In addition, as the fluorine surfactant, a compound having a fluoroalkyl group or a fluoroalkylene group (preferably having 1 to 24 carbon atoms and more preferably 2 to 12 carbon atoms) at any site can be suitably used. Preferably, a polymer compound having the fluoroalkyl group or the fluoroalkylene group at a side chain can be used. It is preferable that the fluorine surfactant further includes the polyoxyalkylene structure, and it is more preferable that the fluorine surfactant includes the polyoxyalkylene structure at a side chain. The compound having the fluoroalkyl group or the fluoroalkylene group can be found in paragraphs “0034” to “0040” of WO2015/190374A, the content of which is incorporated herein by reference.

Examples of the fluorine surfactant include MEGAFACE F171, F172, F173, F176, F177, F141, F142, F143, F144, R30, F437, F479, F482, F554, F559, F780, and F781F (all of which are manufactured by DIC Corporation); FLUORAD FC430, FC431, and FC171 (all of which are manufactured by Sumitomo 3M Ltd.); SURFLON S-382, S-141, S-145, SC-101, SC-103, SC-104, SC-105, SC1068, SC-381, SC-383, S-393, and KH-40 (all of which are manufactured by Asahi Glass Co., Ltd.); F-TOP EF301, EF303, EF351, EF352 (all of which are manufactured by Gemco Inc.); and PF636, PF656, PF6320, PF6520, and PF7002 (all of which manufactured by OMNOVA Solutions Inc.).

In addition, as the fluorine surfactant, a block polymer can also be used. Examples of the block polymer include a compound described in JP2011-089090A. As the fluorine surfactant, a fluorine-containing polymer compound can be preferably used, the fluorine-containing polymer compound including: a repeating unit derived from a (meth)acrylate compound having a fluorine atom; and a repeating unit derived from a (meth)acrylate compound having 2 or more (preferably 5 or more) alkyleneoxy groups (preferably an ethyleneoxy group and a propyleneoxy group). For example, the following compound can also be used as the fluorine surfactant used in the present invention.

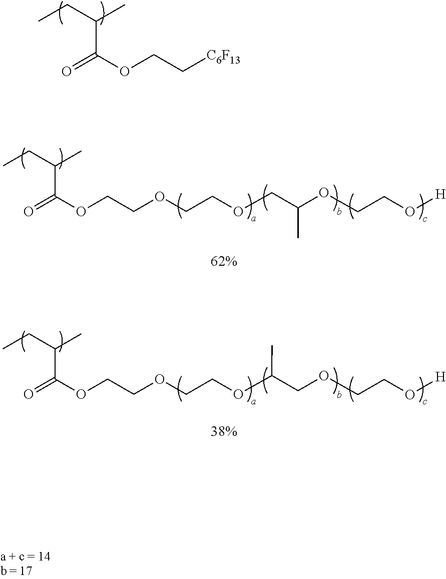

The weight-average molecular weight of the compound is preferably 3000 to 50000 and, for example, 14000. In the compound, “%” representing the proportion of a repeating unit is mol %.

The details of the nonionic surfactant, the anionic surfactant, and the cationic surfactant other than the fluorine surfactant can be found in paragraphs “0042” to “0045” of WO2015/190374A, the content of which is incorporated herein by reference.

In a case where the composition according to the embodiment of the present invention includes a surfactant, the content of the surfactant is preferably 0.01 mass % or higher, more preferably 0.05 mass % or higher, still more preferably 0.1 mass % or higher with respect to the total solid content in the composition. The upper limit is preferably 1 mass % or lower, more preferably 0.75 mass % or lower, and still more preferably 0.5 mass % or lower. By adjusting the content of the surfactant to be the lower limit value or higher, streak-shaped application defects can be improved, which is preferable. By adjusting the content of the colloidal silica particles to be the upper limit value or lower, compatibility can be improved, which is preferable. The composition may include one surfactant or two or more surfactants. In a case where the composition includes two or more surfactants, it is preferable that the total content of the two or more surfactants is in the above-described range.

In addition, it is also preferable that the composition according to the embodiment of the present invention does not substantially include a surfactant. In a case where the composition according to the embodiment of the present invention does not substantially include a surfactant, a hydrophilic film is likely to be laminated on a film formed using the composition according to the embodiment of the present invention. A case where the composition according to the embodiment of the present invention does not substantially include the surfactant represents that the content of the surfactant is 0.005 mass % or lower, preferably 0.001 mass % or lower, and more preferably 0 mass % with respect to the total solid content of the composition.

[Dispersant]

It is also preferable that the composition according to the embodiment of the present invention includes a dispersant. Examples of the dispersant include: a polymer dispersant (for example, polyamideamine or a salt thereof, a polycarboxylic acid or a salt thereof, a high-molecular-weight unsaturated acid ester, a modified polyurethane, a modified polyester, a modified poly(meth)acrylate, a (meth)acrylic copolymer, or a naphthalene sulfonic acid formalin condensate), polyoxyethylene alkyl phosphoric acid ester, polyoxyethylene alkyl amine, and alkanol amine. In terms of a structure, the polymer dispersant can be further classified into a linear polymer, a terminal-modified polymer, a graft polymer, and a block polymer. The polymer dispersant adsorbs on surfaces of particles and functions to prevent reaggregation. Therefore, for example, a terminal-modified polymer a graft polymer, or a block polymer having an anchor site to particle surfaces can be used as a preferable structure. As the dispersant, a commercially available product can also be used. Examples of the commercially available product include products described in paragraph “0050” of WO2016/190374A, the content of which is incorporated herein by reference.

The content of the dispersant is preferably 1 to 100 parts by mass, more preferably 3 to 100 parts by mass, and still more preferably 5 to 80 parts by mass with respect to 100 parts by mass of the content of SiO₂ including the colloidal silica particles. In addition, the content of the dispersant is preferably 1 to 30 mass % with respect to the total solid content of the composition. The composition may include one dispersant or two or more dispersants. In a case where the composition includes two or more dispersants, it is preferable that the total content of the two or more dispersants is in the above-described range.

<<Polymerizable Compounds>>

The composition according to the embodiment of the present invention may include a polymerizable compound. The polymerizable compound may have any chemical form such as a monomer, a prepolymer, that is, a dimer, a trimer, or an oligomer, or a mixture or polymer thereof and is preferably a monomer.

It is preferable that the polymerizable compound is a compound that causes polymerization to occur using active species. Examples of the active species include a radical, an acid, and a base. In a case where the active species is a radical, the radical is preferably a compound having one or more groups having an ethylenically unsaturated bond. In addition, in a case where the active species is an acid such as sulfonic acid, phosphoric acid, sulfinic acid, carboxylic acid, sulfuric acid, or monosulfate, a compound having a cyclic ether group such as an epoxy group or an oxetanyl group can be used. In addition, in a case where the active species is a base such as an amino compound, a compound having a cyclic ether group such as an epoxy group or an oxetanyl group can be used. The polymerizable compound can be optionally used in combination.

As the polymerizable compound, a compound having one or more groups having an ethylenically unsaturated bond is preferable, a compound having two or more groups having an ethylenically unsaturated bond is more preferable, and a compound having three or more groups having an ethylenically unsaturated bond is still more preferable. The upper limit of the number of the groups having an ethylenically unsaturated bond is, for example, preferably 15 or less and more preferably 6 or less. Examples of the group having an ethylenically unsaturated bond include a vinyl group, a styryl group, a (meth)allyl group, and a (meth)acryloyl group. Among these, a (meth)acryloyl group is preferable. The polymerizable compound is preferably a (meth)acrylate compound having 3 to 15 functional groups and more preferably a (meth)acrylate compound having 3 to 6 functional groups.

The details of the polymerizable compound can be found in paragraphs “0059” to “0079” of WO2016/190374A, the content of which is incorporated herein by reference.

In a case where the composition according to the embodiment of the present invention includes a polymerizable compound, the content of the polymerizable compound is preferably 0.01 mass % or higher, more preferably 0.1 mass % or higher, still more preferably 1 mass % or higher with respect to the total solid content in the composition. The upper limit is preferably 20 mass % or lower, more preferably 10 mass % or lower, and still more preferably 5 mass % or lower. In addition, it is also preferable that the composition according to the embodiment of the present invention does not substantially include a polymerizable compound. In a case where the composition according to the embodiment of the present invention does not substantially include a polymerizable compound, an effect of avoiding the occurrence of haze caused by insufficient compatibility between the polymerizable compound and silica can be expected. A case where the composition according to the embodiment of the present invention does not substantially include the polymerizable compound represents that the content of the polymerizable compound is 0.005 mass % or lower, preferably 0.001 mass % or lower, and more preferably 0 mass % with respect to the total solid content of the composition.

<<Polymerization Initiator>>

In a case where the composition according to the embodiment of the present invention includes a polymerizable compound, it is preferable that the composition further includes a polymerization initiator. The polymerization initiator is not particularly limited as long as it has an ability to initiate the polymerization of the polymerizable compound, and can be selected from well-known polymerization initiators. Examples of the polymerization initiator include a photopolymerization initiator and a thermal polymerization initiator and is preferably a photopolymerization initiator. In a case where a radically polymerizable compound is used as the polymerizable compound, it is preferable that a radical polymerization initiator is used as the polymerization initiator, and it is more preferable that a photoradical polymerization initiator is used as the polymerization initiator. Examples of the photoradical polymerization initiator include a trihalomethyltriazine compound, a benzyldimethylketal compound, an α-hydroxy ketone compound, an α-aminoketone compound, an acylphosphine compound, a phosphine oxide compound, a metallocene compound, an oxime compound, a triarylimidazole dimer, an onium compound, a benzothiazole compound, a benzophenone compound, an acetophenone compound, a cyclopentadiene-benzene-iron complex, a halomethyl oxadiazole compound, and a coumarin compound. Among these, an oxime compound, an α-hydroxy ketone compound, an α-aminoketone compound, or an acylphosphine compound is preferable, and an oxime compound or an α-aminoketone compound is more preferable. The details of the polymerization initiator can be found in paragraphs “0099” to “0125” of JP2015-166449A, the content of which is incorporated herein by reference.

In a case where the composition according to the embodiment of the present invention includes a polymerization initiator, the content of the polymerization initiator is preferably 0.01 mass % or higher, more preferably 0.1 mass % or higher, still more preferably 1 mass % or higher with respect to the total solid content in the composition. The upper limit is preferably 20 mass % or lower, more preferably 10 mass % or lower, and still more preferably 5 mass % or lower. In addition, it is also preferable that the composition according to the embodiment of the present invention does not substantially include a polymerization initiator. A case where the composition according to the embodiment of the present invention does not substantially include the polymerization initiator represents that the content of the polymerization initiator is 0.005 mass % or lower, preferably 0.001 mass % or lower, and more preferably 0 mass % with respect to the total solid content of the composition.

<<Adherence Improving Agent>>

The composition according to the embodiment of the present invention may further include an adherence improving agent. By the composition including the adherence improving agent, a film having excellent adhesiveness with a support can be formed. Preferable examples of the adherence improving agent include adherence improving agents described in JP1993-011439A (JP-H5-011439A), JP1993-341532A (JP-H5-341532A), and JP1994-043638A (JP-H6-043638A). Specific examples of the adherence improving agent include benzimidazole, benzoxazole, benzothiazole, 2-mercaptobenzimidazole, 2-mercaptobenzoxazole, 2-mercaptobenzothiazole, 3-morpholinomethyl-1-phenyl-triazole-2-thione, 3 -morpholinomethyl-5-phenyl-oxadiazole-2-thione, 5-amino-3-morpholinomethyl-thiadiazole-2-thione, 2-mercapto-5-methylthiothiadiazole, triazole, tetrazole, benzotriazole, carboxybenzotriazole, an amino group-containing benzotriazole, and a silane coupling agent. As the adherence improving agent, a silane coupling agent is preferable.

As the silane coupling agent, a compound having an alkoxysilyl group as a hydrolyzable group that can form a chemical bond with an inorganic material is preferable. In addition, a compound having a group which interacts with a resin or forms a bond with a resin to exhibit affinity is preferable, and examples of the group include a vinyl group, a styryl group, a (meth)acryloyl group, a mercapto group, an epoxy group, an oxetanyl group, an amino group, an ureido group, a sulfide group, and an isocyanate group. Among these, a (meth)acryloyl group or an epoxy group is preferable.

As the silane coupling agent, a silane compound that has at least two functional groups having different reactivities in one molecule is also preferable. In particular, a compound having an amino group and alkoxy group as functional groups is preferable. Examples of the silane coupling agent include N-β-aminoethyl-γ-aminopropyl-methyldimethoxysilane (KBM-602, manufactured by Shin-Etsu Chemical Co., Ltd.), N-β-aminoethyl-γ-aminopropyl-trimethoxysilane (KBM-603, manufactured by Shin-Etsu Chemical Co., Ltd.), N-β-aminoethyl-γ-aminopropyl-triethoxysilane (KBE-602, trade name, manufactured by Shin-Etsu Chemical Co., Ltd.), γ-aminopropyl-trimethoxysilane (KBM-903, trade name, manufactured by Shin-Etsu Chemical Co., Ltd.), γ-aminopropyl-triethoxysilane (KBE-903, trade name, manufactured by Shin-Etsu Chemical Co., Ltd.), and 3-methacryloxypropyltrimethoxysilane (KBM-503, trade name, manufactured by Shin-Etsu Chemical Co., Ltd.). As the silane coupling agent, the following compounds can also be used. In the following structural formulae, Et represents an ethyl group.

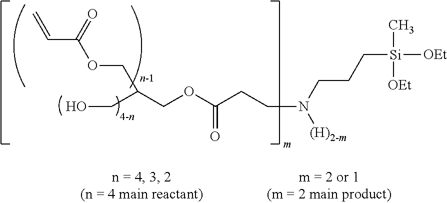

In a case where the composition according to the embodiment of the present invention includes an adherence improving agent, the content of the adherence improving agent is preferably 0.001 mass % or higher, more preferably 0.01 mass % or higher, still more preferably 0.1 mass % or higher with respect to the total solid content in the composition. The upper limit is preferably 20 mass % or lower, more preferably 10 mass % or lower, and still more preferably 5 mass % or lower. In addition, it is also preferable that the composition according to the embodiment of the present invention does not substantially include an adherence improving agent. A case where the composition according to the embodiment of the present invention does not substantially include the adherence improving agent represents that the content of the adherence improving agent is 0.0005 mass % or lower, preferably 0.0001 mass % or lower, and more preferably 0 mass % with respect to the total solid content of the composition.

A storage container of the composition according to the embodiment of the present invention is not particularly limited, and a well-known storage container can be used. In addition, as the storage container, in order to suppress infiltration of impurities into the raw materials or the composition, a multilayer bottle in which a container inner wall having a six-layer structure is formed of six kinds of resins or a bottle in which a container inner wall having a seven-layer structure is formed of six kinds of resins is preferably used. Examples of the container include a container described in JP2015-123351A.

The composition according to the embodiment of the present invention can be preferably used as a composition for forming an optical functional layer in an optical device such as a display panel, a solar cell, an optical lens, a camera module, or an optical sensor. Examples of the optical functional layer include an antireflection layer, a low refractive index layer, and a waveguide. In addition, the composition according to the embodiment of the present invention can be preferably used as a composition for forming a partition wall. Examples of the partition wall include a partition wall dividing pixels adjacent to each other in a case where pixels are formed on an imaging area of a solid image pickup element. Examples of the pixel include a colored pixel, a transparent pixel, and a pixel of a near infrared transmitting filter layer. For example, a partition wall for forming a grid structure for dividing pixels can be used. Examples of the partition wall include structures described in JP2012-227478A, JP2010-0232537A, JP2009-111225A, FIG. 1 of JP2017-028241A, and FIG. 4D of JP2016-201524A, the contents of which are incorporated herein by reference. In addition, for example, a partition wall for forming a frame structure around an optical filter such as a color filter or a near infrared transmitting filter can be used. Examples of the partition wall include a structure described in JP2014-048596A, the content of which is incorporated herein by reference.

The refractive index of the film formed using the composition according to the embodiment of the present invention is preferably 1.5 or lower, more preferably 1.4 or lower, still more preferably 1.3 or lower, and still more preferably 1.24 or lower. The lower limit is practically 1.1 or higher. Unless specified otherwise, the value of the refractive index is a value measured at 25° C. using light having a wavelength of 633 nm.

It is preferable that the film has sufficient hardness. The Young's modulus of the film is preferably 2 or higher, more preferably 3 or higher, and still more preferably 4 or higher. The upper limit value is practically 10 or lower.

The thickness of the film varies depending on the use. For example, the thickness of the film is preferably 5 μm or less, more preferably 3 μm or less, and still more preferably 1.5 μm or less. The lower limit value is not particularly limited, but is practically 50 nm or more.

<Method of Manufacturing Composition>

The composition according to the embodiment of the present invention can be manufactured by mixing the above-described compositions. During the manufacturing of the composition, it is preferable that the composition is filtered through a filter, for example, in order to remove foreign matter or to reduce defects. As the filter, any filter which is used in the related art for filtering or the like can be used without any particular limitation. Examples of a material of the filter include: a fluororesin such as polytetrafluoroethylene (PTFE); a polyamide resin such as nylon; and a polyolefin resin (including a polyolefin resin having a high density and an ultrahigh molecular weight) such as polyethylene or polypropylene (PP). Among these materials, polypropylene (including high-density polypropylene) or nylon is preferable.

The pore size of the filter is suitably about 0.1 to 7 μm and is preferably about 0.2 to 2.5 μm, more preferably about 0.2 to 1.5 μm, and still more preferably 0.3 to 0.7 μm. In the above-described range, fine foreign matter such as impurities or aggregates can be more reliably removed while suppressing filter clogging.

In a filter is used, a combination of different filters may be used. At this time, the filtering using a first filter may be performed once, or twice or more. In a case where filtering is performed two or more times using different filters in combination, it is preferable that the pore size of the filter (also referred to as “first filter”) used for the first filtering is more than or equal to the pore size of the filter (also referred to as “second filter”) used for the second or subsequent filtering. Here, the pore size of the filter can refer to a nominal value of a manufacturer of the filter. A commercially available filter can be selected from various filters manufactured by Pall Corporation, Toyo Roshi Kaisha, Ltd., Entegris Japan Co., Ltd. (former Mykrolis Corporation), or Kits Microfilter Corporation.

The second filter may be formed of the same material as that of the first filter. The pore size of the second filter is suitably about 0.2 to 10.0 μm and is preferably about 0.2 to 7.0 μm and more preferably about 0.3 to 6.0 μm. In the above-described range, foreign matter incorporated into the composition can be removed while allowing the component particles included in the composition to remain.

<Film Forming Method>

Next, a film forming method according to the embodiment of the present invention will be described. The film forming method according to the embodiment of the present invention includes a step of applying the composition according to the embodiment of the present invention. Examples of a method of applying the composition include: a drop casting method; a slit coating method; a spray coating method; a roll coating method; a spin coating method; a cast coating method; a slit and spin method; a pre-wetting method (for example, a method described in JP2009-145395A); various printing methods including jet printing such as an ink jet method (for example, an on-demand method, a piezoelectric method, or a thermal method) or a nozzle jet method, flexographic printing, screen printing, gravure printing, reverse offset printing, and metal mask printing; a transfer method using a mold or the like; and a nanoimprint lithography method. The application method using an ink jet method is not particularly limited, and examples thereof include a method (in particular, pp. 115 to 133) described in “Extension of Use of Ink Jet—Infinite Possibilities in Patent—” (February, 2005, S.B. Research Co., Ltd.) and methods described in JP2003-262716A, JP2003-185831A, JP2003-261827A, JP2012-126830A, and JP2006-169325A. In addition, it is preferable that the application using a spin coating method is performed at a rotation speed of 1000 to 2000 rpm. In addition, during the coating using a spin coating method, the rotation speed may be increased as described in JP1998-142603A (JP-H10-146203A), JP1999-302413A (JP-H11-302413A), or JP2000-157922A. In addition, a spin coating process described in “Process Technique and Chemicals for Latest Color Filter”(Jan. 31, 2006, CMC Publishing Co., Ltd.) can also be suitably used. The support to which the composition is applied is appropriately selected depending on the use. Examples of the support include a substrate formed of a material such as silicon, non-alkali glass, soda glass, PYREX (registered trade name) glass, or quartz glass. In addition, for example, an InGaAs substrate is preferably used. The InGaAs substrate has excellent sensitivity to light having a wavelength of longer than 1000 nm. Therefore, by forming the respective near infrared transmitting filter layers on the InGaAs substrate, an optical sensor having excellent sensitivity to light having a wavelength of longer than 1000 nm is likely to be obtained. In addition, a charge coupled device (CCD), a complementary metal-oxide semiconductor (CMOS), a transparent conductive film, or the like may be formed on the support. In addition, a black matrix formed of a light shielding material such as tungsten may also be formed on the support. In addition, an underlayer may be provided on the support to improve adhesiveness with a layer above the support, to prevent diffusion of materials, or to make a surface of the substrate flat. In addition, as the support, a microlens can also be used. By applying the composition according to the embodiment of the present invention to the microlens to faun a film, a microlens unit having a surface coated with the film formed of the composition according to the embodiment of the present invention can be obtained. This microlens unit can be used in combination with an optical sensor such as a solid image pickup element.

In the present invention, it is preferable that the composition layer formed on the support is dried (pre-baked). It is preferable that drying is performed using a hot plate, an oven, or the like at a temperature of 50° C. to 140° C. for 10 seconds to 300 seconds.

In addition, in the present invention, the composition layer may be heated (post-baked) after drying. Post-baking is a heat treatment which is performed after development to completely cure the composition layer. The post-baking temperature is preferably 250° C. or lower, more preferably 240° C. or lower, and still more preferably 230° C. or lower. The lower limit is not particularly limited, and is preferably 50° C. or higher and more preferably 100° C. or higher.

In addition, in the present invention, it is preferable that a surface adhesion treatment is performed on the dried and heated composition layer. It is preferable that an adhesion treatment is performed on the surface of the composition layer to make the surface hydrophobic. Examples of the adhesion treatment include a HMDS treatment. As the treatment, hexamethyldisilazane (HMDS) is used. In a case where HMDS is applied to the composition layer formed using the composition according to the embodiment of the present invention, HMDS reacts with a Si—OH bond present on the surface to form Si—O—Si(CH₃)₃. As a result, the surface of the composition layer can be made hydrophobic. This way, by making the surface of the composition layer hydrophobic, in a case where a resist pattern described below is formed on the composition layer, the infiltration of a developer into the composition layer can be prevented while improving the adhesiveness of the resist pattern.

The film forming method according to the embodiment of the present invention may further include a step of forming a pattern. It is preferable that a step of forming a pattern includes: a step of forming a resist pattern on the composition layer formed by applying the composition according to the embodiment of the present invention; a step of etching the composition layer using this resist pattern as a mask; and a step of peeling and removing the resist pattern from the composition layer.

A resist used for forming the resist pattern is not particularly limited. For example, a resist including an alkali-soluble phenol resin and naphthoquinone diazide described in pp. 16 to 22 of “Polymer New Material. One Point 3, Microfabrication and Resist, Saburo Nonomura, Published by Kyoritsu Shuppan Co., Ltd. (First Edition, Nov. 15, 1987) can be used. More specifically, a resist described in Examples of JP2568883B, JP2761786B, JP2711590B, JP2987526B, JP3133881B, JP3501427B, JP3373072B, JP3361636B, or JP1994-054383A (JP-H6-054383A) can be used, the contents of which are incorporated herein by reference. In addition, as the resist, a so-called chemically amplified resist can also be used. Examples of the chemically amplified resist include a resist described in p. 129˜ of “New Developments of Photo-functional Polymer Materials”, (May 31, 1996, first print, edited by Kunihiro Ichimura, published by CMC) (in particular, a resist including a polyhydroxystyrene resin in which a hydroxyl group is protected by an acid-decomposable group that is described in about page 131 or an ESCAP type resist that is described in about page 131 is preferable). More specifically, a resist described in, for example, Examples of JP2008-268875A, JP2008-249890A, JP2009-244829A, JP2011-013581A, JP2011-232657A, JP2012-003070A, JP2012-003071A, JP3638068B, JP4006492B, JP4000407B, or JP4194249B can be used. The contents of this specification are incorporated herein by reference.

A method of etching the composition layer may be a dry etching method or a wet etching method. Among these, a diy etching method is preferable. As the diy etching, for example, a dry etching method using mixed gas including fluorine gas and O₂ at a mixing ratio (flow rate ratio) of 4/1 to 1/5 (fluorine gas/O₂) can be performed. The details of the dry etching method can be found in paragraphs “0102” to “0108” of WO2015/190374A or JP2016-014856A, the contents of which are incorporated herein by reference.

<Method of Manufacturing Optical Sensor>

Next, a method of manufacturing an optical sensor according to the embodiment of the present invention will be described. The method of manufacturing an optical sensor according to the embodiment of the present invention includes a step of applying the composition according to the embodiment of the present invention. Regarding the details of the method of manufacturing an optical sensor, the method described above regarding the film forming method can be applied. Examples of the optical sensor include an image sensor such as a solid image pickup element. Examples of one aspect of the optical sensor according to a preferred embodiment of the present invention include a configuration in which the film formed using the composition according to the embodiment of the present invention is applied to an antireflection film on a microlens, an intermediate film, or a partition wall such as a grid disposed in a frame of a color filter or a near infrared transmitting filter or between pixels.

Examples of one embodiment of the optical sensor include a structure configured with a light-receiving element (photodiode), a lower planarizing film, an optical filter, an upper planarizing film, or a microlens. Examples of the optical filter include a filter including a colored pixel of red (R), green (G), blue (B), or the like or a pixel of a near infrared transmitting filter layer. In a case where the optical filter includes a plurality of pixels, it is preferable that a difference in height between upper surfaces of the respective pixels is substantially the same. The upper planarizing film is formed to cover the upper surface of the optical filter such that the optical filter surface is planarized. The microlens is a collecting lens that is arranged in a state where a convex surface faces upward and is provided above the upper planarizing film and the light-receiving element. That is, the microlens, the pixel portion of the optical filter, and the light-receiving element are arranged in series along a light incidence direction such that light incident from the outside can be efficiently guided to each light-receiving element. Although the detailed description of the light-receiving element and the microlens will not be made, configurations that are typically applied to these products can be appropriately used.

### EXAMPLES

Next, the present invention will be described using Examples, but the present invention is not limited thereto. Unless specified otherwise, amounts or ratios shown in Examples are represented by mass.

### Example 1

### Preparation of Colloidal Silica Particle Solution

First, tetraethoxysilane (TEOS) was prepared as silicon alkoxide (A), and trifluoropropyltrimethoxysilane (TFPTMS) was used as a fluoroalkyl group-containing silicon alkoxide (B). The silicon alkoxide (A) and the fluoroalkyl group-containing silicon alkoxide (B) were weighed such that the proportion (mass ratio) of the fluoroalkyl group-containing silicon alkoxide (B) was 0.6 with respect to 1 of the mass of the silicon alkoxide (A), were put into a separable flask, and were mixed with each other to obtain a mixture. Propylene glycol monomethyl ether (PGME) was added to the mixture such that the amount thereof was 1.0 part by mass with respect to 1.0 part by mass, and the solution was stirred at a temperature of 30° C. for 15 minutes to prepare a first solution.

In addition, separately from the first solution, ion exchange water and formic acid were added to the above-described mixture such that the amount of ion exchange water was 1.0 part by mass and the amount of formic acid was 0.01 parts by mass with respect to 1.0 part by mass of the mixture, and the components were mixed and stirred at a temperature of 30° C. for 15 minutes to prepare a second solution.

Next, the prepared first solution was held in a water bath at a temperature of 55° C., the second solution was added to this first solution, and the obtained solution was stirred for 60 minutes in a state where it was held at the temperature. As a result, a solution F including a hydrolysate of the silicon alkoxide (A) and the fluoroalkyl group-containing silicon alkoxide (B) was obtained. The concentration of solid contents in the solution F was 10 mass % in terms of SiO₂.

Next, 0.1 parts by mass of a calcium nitrate aqueous solution having a concentration of 30 mass % was added to 100 parts by mass of an aqueous dispersion including 30 mass % of commercially available colloidal silica (trade name: ST-30, manufactured by Nissan Chemical industries Ltd.) having an average diameter of 15 nm to prepare a mixed solution, and this mixed solution was heated at 120° C. in a stainless steel autoclave for 5 hours.

This mixed solution was filtered using an ultrafiltration method such that the solvent was replaced with propylene glycol monomethyl ether, was further stirred and sufficiently dispersed using a homomixer (manufactured by Primix Corporation) at a rotation speed of 14000 rpm for 30 minutes, and propylene glycol monomethyl ether was further added. As a result, a colloidal silica particle solution G having a concentration of solid contents of 15 mass % was obtained.

30 parts by mass of the solution F and 70 parts by mass of the colloidal silica particle solution G were mixed with each other. Further, the mixture was heated at 40° C. for 10 hours and was centrifugally separated at 1000 G for 10 minutes to remove precipitates. As a result, a colloidal silica particle solution P1 was obtained. Colloidal silica particle solutions P2 and P3 shown in Table 1 below were prepared by appropriately changing manufacturing conditions or raw materials.

TABLE 1

| No1 | D0 (nm) | D1 (nm) | D2 (nm) | D1/D2 |
|---|---|---|---|---|
| P1 | 15 | 80 | 15 | 5.3 |
| P2 | 10 | 80 | 18 | 4.4 |
| P3 | 20 | 100 | 13 | 7.7 |

D0: an average particle size of spherical silica (a circle equivalent diameter of a projection image of a spherical portion measured using a transmission electron microscope (TEM))
D1: an average particle size of colloidal silica particles measured using a dynamic light scattering method
D2: an average particle size of colloidal silica particles obtained from a specific surface area

Preparation of Composition

Using the colloidal silica particle solution obtained as described above, the respective components were mixed so as to obtain a composition shown in Table 2 below. As a result, a composition was obtained. After the preparation of the colloidal silica particle solutions and the preparation of the compositions, each of the compositions was filtered using DFA4201NXEY (a 0.45 μm nylon filter, manufactured by Pall Corporation).

TABLE 2

| | | | | | Solvent | | |
|---|---|---|---|---|---|---|---|
| | | Particle | Other Silica | | Solvent | Solvent | |
| | | Solution | Particles | Surfactant | A1 | A2 | Other Solvents |
| Example 1 | Kind | P1 | | F1 | A1-1 | A2-1 | PGME/LC-OH/W |
| | Addition | 10 | | 0.02 | 7 | 35 | 43/4/1 |
| | Amount | | | | | | |
| Example 2 | Kind | P1 | | F2 | A1-1 | A2-1 | PGME/LC-OH/W |
| | Addition | 8 | | 0.02 | 5 | 39 | 43/4/1 |
| | Amount | | | | | | |
| Example 3 | Kind | P1 | | F3 | A1-1 | A2-1 | PGME/LC-OH/W |
| | Addition | 12 | | 0.02 | 10 | 23 | 50/4/1 |
| | Amount | | | | | | |
| Example 4 | Kind | P1 | | F1 | A1-1 | A2-1 | PGME/LC-OH/W |
| | Addition | 10 | | 0.02 | 7 | 35 | 43/4/1 |
| | Amount | | | | | | |
| Example 5 | Kind | P1 | | F1 | A1-1 | A2-3 | PGME/LC-OH/W |
| | Addition | 10 | | 0.03 | 9 | 20 | 54/6/1 |
| | Amount | | | | | | |
| Example 6 | Kind | P1 | | F1 | A1-1 | A2-2 | PGME/LC-OH/W |
| | Addition | 4 | | 0.02 | 10 | 25 | 54/6/1 |
| | Amount | | | | | | |
| Example 7 | Kind | P1 | | F1 | A1-2 | A2-1 | PGME/LC-OH/W |
| | Addition | 10 | | 0.02 | 15 | 30 | 40/4/1 |
| | Amount | | | | | | |
| Example 8 | Kind | P1 | | F2 | A1-3 | A2-1 | PGME/LC-OH/W |
| | Addition | 10 | | 0.03 | 9 | 40 | 36/4/1 |
| | Amount | | | | | | |
| Example 9 | Kind | P1 | | F3 | A1-4 | A2-1 | PGME/LC-OH/W |
| | Addition | 10 | | 0.02 | 9 | 30 | 46/4/1 |
| | Amount | | | | | | |
| Example 10 | Kind | P1 | | F3 | A1-1 | A2-1/A2-3 | PGME/LC-OH/W |
| | Addition | 10 | | 0.02 | 9 | 30/6 | 40/4/1 |
| | Amount | | | | | | |
| Example 11 | Kind | P2 | | F1 | A1-1 | A2-1 | PGME/LC-OH/W |
| | Addition | 12 | | 0.02 | 10 | 23 | 50/4/1 |
| | Amount | | | | | | |
| Example 12 | Kind | P3 | | F1 | A1-1 | A2-1 | PGME/LC-OH/W |
| | Addition | 12 | | 0.02 | 10 | 23 | 50/4/1 |
| | Amount | | | | | | |
| Example 13 | Kind | P1 | P4 | F1 | A1-1 | A2-1 | PGME/LC-OH/W |
| | Addition | 8 | 2 | 0.02 | 7 | 35 | 43/4/1 |
| | Amount | | | | | | |
| Example 14 | Kind | P1 | P5 | F1 | A1-1 | A2-1 | PGME/LC-OH/W |
| | Addition | 7 | 3 | 0.02 | 7 | 35 | 43/4/1 |
| | Amount | | | | | | |
| Example 15 | Kind | P1 | | | A1-1 | A2-1 | PGME/LC-OH/W |
| | Addition | 12 | | | 10 | 23 | 50/4/1 |
| | Amount | | | | | | |
| Example 16 | Kind | P1 | | F1 | A1-1 | A2-2 | PGME/LC-OH/W |
| | Addition | 10 | | 0.02 | 12 | 21 | 50/4/1 |
| | Amount | | | | | | |
| Example 17 | Kind | P1 | | F1 | A1-1 | A2-1 | PGME/LC-OH/W |
| | Addition | 10 | | 0.02 | 5 | 47 | 43/4/1 |
| | Amount | | | | | | |
| Example 18 | Kind | P1 | P6 | F1 | A1-1 | A2-1 | PGME/LC-OH/W/PGMEA/1,3-BDGA |
| | Addition | 2 | 8 | 0.02 | 10 | 23 | 25/2/1/18/7 |
| | Amount | | | | | | |
| Example 19 | Kind | P1 | | F1 | A1-1/A1-5 | A2-1 | PGME/LC-OH/W |
| | Addition | 7 | | 0.02 | 1/6 | 35 | 48/4/1 |
| | Amount | | | | | | |
| Example 20 | Kind | P1 | | F1 | A1-6/A1-5 | A2-1 | PGME/LC-OH/W |
| | Addition | 7 | | 0.02 | 1/6 | 35 | 48/4/1 |
| | Amount | | | | | | |
| Example 21 | Kind | P1 | | F1 | A1-7/A1-5 | A2-1 | PGME/LC-OH/W |
| | Addition | 7 | | 0.02 | 1/6 | 35 | 48/4/1 |
| | Amount | | | | | | |
| Comparative | Kind | P1 | | | | | PGME/GE/LC-OH/W |
| Example 1 | Addition | 10 | | | | | 50/35/4/1 |
| | Amount | | | | | | |

Numerical values of the addition amounts in the following table are represented by “part(s) by mass”. In addition, the addition amount of the particle solution is the SiO₂ content in the particle solution. A numerical value of the addition amount of the solvent is the sum of the amounts of the solvents included in the particle solution. The raw materials shown above in the table are as follows.

(Particle Solution)

P1 to P3: the above-described particle solutions P1 to P3
P4: THRULYA 4110 (manufactured by JGC C&C)
P5: PL-2L-IPA (manufactured by Fuso Chemical Co., Ltd.)
P6: siloxane polymer (the following structure, Mw=10000)

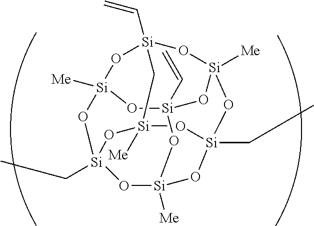

(Solvent A1)
A1-1: polyethylene glycol monomethyl ether (molecular weight: 550, solubility parameter=lower than 11.3 (cal/cm³)^{0.5}, boiling point=245° C. or higher)
A1-2: triethylene glycol monomethyl ether (molecular weight: 164, solubility parameter=10.5 (cal/cm³)^{0.5}, boiling point=248° C.)
A1-3: triethylene glycol monobutyl ether (molecular weight: 206, solubility parameter=9.6 (cal/cm³)^{0.5}, boiling point=278° C.)
A1-4: 3-butoxy-N,N-dimethylpropanamide (molecular weight: 173, solubility parameter=10.3 (cal/cm³)^{0.5}, boiling point−252° C.)
A1-5: polyethylene glycol monomethyl ether (molecular weight: 220, solubility parameter=lower than 11.3 (cal/cm³)^{0.5}, boiling point=245° C. or higher)
A1-6: polyethylene glycol monomethyl ether (molecular weight: 400, solubility parameter=lower than 11.3 (cal/cm³)^{0.5}, boiling point=245° C. or higher)
A1-7: polyethylene glycol monomethyl ether (molecular weight: 1000, solubility parameter=lower than 11.3 (cal/cm³)^{0.5}, boiling point=245° C. or higher)

(Solvent A2)
A2-1: ethyl lactate (molecular weight: 118, solubility parameter=12.1 (cal/cm³)^{0.5}, boiling point=154° C.)
A2-2: propylene carbonate (molecular weight: 102, solubility parameter=13.3 (cal/cm³)^{0.5}, boiling point=240° C.)
A2-3: ethylene glycol (molecular weight: 62, solubility parameter=14.2 (cal/cm³)^{0.5}, boiling point=197° C.)

(Other Solvents)
PGME: propylene glycol monomethyl ether (solubility parameter=11.2 (cal/cm³)^{0.5}, boiling point=120° C.)
W: water (solubility parameter=23.4 (cal/cm³)^{0.5}, boiling point=100° C.)
LC-OH: ethanol, methanol, a mixture thereof (solubility parameter of methanol=14.5 cal/cm³)^{0.5}, boiling point of methanol=64° C., solubility parameter of ethanol=12.7 cal/cm³)^{0.5}, boiling point of ethanol=78° C.)
GE: glycerin (solubility parameter=16.5 (cal/cm³)^{0.5}, boiling point=290° C.)
1,3-BDGA: 1,3-butylene glycol diacetate (solubility parameter=9.7 (cal/cm³)^{0.5}, boiling point=232° C.)

(Surfactant)
F1: a compound having the following structure Mw=14,000, “%” representing the proportion of a repeating unit is mol %)

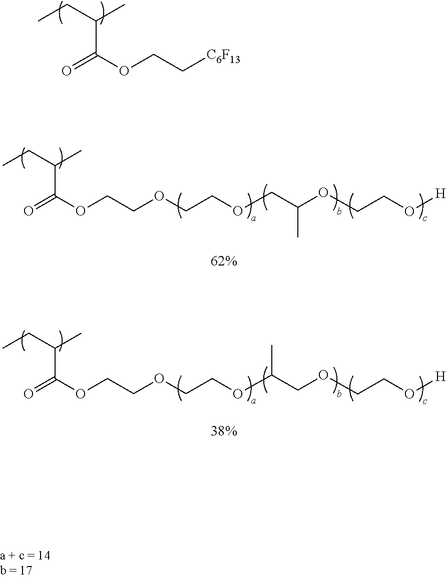

F2: MEGAFACE F554 (manufactured by DIC Corporation)
F3: MEGAFACE F559 (manufactured by DIC Corporation)

[Evaluation]

In a clean room of class 1000, the composition obtained as described above was applied to an 8-inch (=20.32 cm) silicon wafer using a spin coating method such that the thickness after the application was 0.6 μm. Next, the applied composition was heated at 100° C. for 2 minutes and was heated at 220° C. for 5 minutes. As a result, a film was formed. The obtained film was evaluated as follows. The results are shown in Table 2 below.

<Surface Shape (Uniformity)>

The surface shape (the state of striation) of the obtained film was observed at a magnification of 50-fold with a semiconductor inspection microscope MX50 (manufactured by Olympus Corporation)

The results were divided and determined based on the following standards.
A: a streak-shaped uneven portion was not observed in the entire film
B: less than three streak-shaped uneven portions were observed in the entire film
C: 3 or more and less than 10 streak-shaped uneven portions were observed in the entire film
D: 10 or more streak-shaped uneven portions were observed in the entire film, which was not practicable

<Refractive Index>

The refractive index of the obtained film was measured using an ellipsometer (VUV-vase (trade name), manufactured by J. A. Woollam Co., Inc.) (wavelength: 633 nm, measurement temperature: 25° C.)

<Number of Defects>

The number of defects in the obtained film was inspected using a wafer defect evaluation device ComPlus3 (manufactured by Applied Materials, Inc.). The number of defects having a size of 0.5 μm or more in an optical microscopic image was counted.

TABLE 3

| | Evaluation | | |
|---|---|---|---|
| | Surface | Refractive | Number |
| | Shape | Index | of Defects |
| Example 1 | A | 1.24 | 34 |
| Example 2 | A | 1.23 | 48 |
| Example 3 | A | 1.24 | 42 |
| Example 4 | A | 1.24 | 23 |
| Example 5 | A | 1.25 | 78 |
| Example 6 | A | 1.23 | 500 |
| Example 7 | A | 1.23 | 134 |
| Example 8 | A | 1.23 | 128 |
| Example 9 | A | 1.22 | 198 |
| Example 10 | A | 1.22 | 52 |
| Example 11 | A | 1.22 | 23 |
| Example 12 | A | 1.22 | 44 |
| Example 13 | B | 1.26 | 151 |
| Example 14 | B | 1.29 | 298 |
| Example 15 | C | 1.24 | 450 |
| Example 16 | B | 1.19 | 400 |
| Example 17 | C | 1.26 | 222 |
| Example 18 | B | 1.29 | 298 |
| Example 19 | A | 1.24 | 38 |
| Example 20 | A | 1.25 | 46 |
| Example 21 | A | 1.24 | 62 |
| Comparative | D | 1.25 | 2321 |
| Example 1 | | | |

As shown in the tables, in Examples, a film having a low refractive index and reduced defects was able to be formed.

In addition, in each of Examples, the same effect was obtained even in a case where a mixed solvent including three or more alcohols selected from the group consisting of methanol, ethanol, 1-propanol, 2-propanol, 1-butanol, and 2-butanol was used instead of LC-OH.

In a case where each of partition walls 40 to 43 in FIG. 1 of JP2017-028241A was formed using the composition according to any one of Examples 1 to 18 to form an image sensor, this image sensor had excellent sensitivity.

What is claimed is:

1. A composition comprising:
colloidal silica particles; and
a solvent,
wherein in the colloidal silica particles, an average particle size D₁ that is measured using a dynamic light scattering method is 25 to 1000 nm and a ratio D₁/D₂ of the average particle size D₁ to an average particle size D₂ that is obtained by the following Expression (1) from a specific surface area S of the colloidal silica particles measured using a nitrogen adsorption method is 3 or higher, and
the solvent includes a solvent A1 having a boiling point of 245° C. or higher and a solubility parameter of lower than 11.3 (cal/cm³)^{0.5} and a solvent A2 having a boiling point of 120° C. or higher and lower than 245° C. and a solubility parameter of 11.3 (cal/cm³)^{0.5} or higher,
D₂=2720/S (1),
where D₂ represents an average particle size with a unit of nm and S represents a specific surface area of colloidal silica particles measured using a nitrogen adsorption method with a unit of m²/g.

2. A composition comprising:
colloidal silica particles; and
a solvent,
wherein in the colloidal silica particles, a plurality of spherical silica particles are linked in a planar shape, and
the solvent includes a solvent A1 having a boiling point of 245° C. or higher and a solubility parameter of lower than 11.3 (cal/cm³)^{0.5} and a solvent A2 having a boiling point of 120° C. or higher and lower than 245° C. and a solubility parameter of 11.3 (cal/cm³)^{0.5} or higher.

3. A composition comprising:
colloidal silica particles; and
a solvent,
wherein in the colloidal silica particles, a plurality of spherical silica particles are linked in a beaded shape, and
the solvent includes a solvent A1 having a boiling point of 245° C. or higher and a solubility parameter of lower than 11.3 (cal/cm³)^{0.5} and a solvent A2 having a boiling point of 120° C. or higher and lower than 245° C. and a solubility parameter of 11.3 (cal/cm³)^{0.5} or higher.

4. The composition according to claim 1,
wherein in the colloidal silica particles, a plurality of spherical silica particles having an average particle size of 1 to 80 nm are linked through a linking material.

5. The composition according to claim 4,
wherein the linking material is a metal oxide-containing silica.

6. The composition according to claim 1,
wherein at least one selected from the solvent A1 or the solvent A2 is a protonic solvent.

7. The composition according to claim 1,
wherein the solvent A1 and the solvent A2 are protonic solvents.

8. The composition according to claim 1,
wherein a content of the solvent A2 is 200 to 800 parts by mass with respect to 100 parts by mass of the solvent A1.

9. The composition according to claim 1,
wherein a total content of the solvent A1 and the solvent A2 is 30 to 70 mass % with respect to all the solvents.

10. The composition according to claim 1, which is used for forming an optical functional layer.

11. The composition according to claim 1, which is used for forming a partition wall.

12. A film forming method comprising:
a step of applying the composition according to claim 1.

13. A method of manufacturing an optical sensor comprising:
a step of applying the composition according to claim 1.

14. The composition according to claim 2,
wherein in the colloidal silica particles, a plurality of spherical silica particles having an average particle size of 1 to 80 nm are linked through a linking material.

15. The composition according to claim 3,
wherein in the colloidal silica particles, a plurality of spherical silica particles having an average particle size of 1 to 80 nm are linked through a linking material.

16. The composition according to claim 2,
wherein at least one selected from the solvent A1 or the solvent A2 is a protonic solvent.

17. The composition according to claim 3,
wherein at least one selected from the solvent A1 or the solvent A2 is a protonic solvent.

18. The composition according to claim 2,
wherein a content of the solvent A2 is 200 to 800 parts by mass with respect to 100 parts by mass of the solvent A1.

19. The composition according to claim 3,
wherein a content of the solvent A2 is 200 to 800 parts by mass with respect to 100 parts by mass of the solvent A1.
